(19) United States
(12) Patent Application Publication
(10) Pub. No.: US 2002/0184803 A1
(43) Pub. Date: Dec. 12, 2002

(54) Inscription method for an electrical appliance

(76) Inventor: Gerhard Kaiser, Amberg (DE)

Correspondence Address: HARNESS, DICKEY & PIERCE, P.L.C., P.O.BOX 8910, RESTON, VA, 20195, US

(21) Appl. No.: 10/125,489

(22) Filed: Apr. 19, 2002

(30) Foreign Application Priority Data
Apr. 20, 2001 (DE) 10119456.0

(51) Int. Cl. B65G 51/42

(52) U.S. Cl. 40/486; 406/4; 100/70 R

(57) ABSTRACT

Information elements for a user of an electrical appliance are applied by an application device to a control panel on an electrical appliance. In this case, the application device includes an associated control command. The information elements are applied to the control panel by the application device, depending on the control command, in a predetermined first representation combination or in a predetermined second representation combination.

The present application hereby claims priority under 35 U.S.C. §119 on German patent publication number DE 10119456.0 filed Apr. 20, 2001, the entire contents of which are hereby incorporated by reference.

### FIELD OF THE INVENTION

The present invention generally relates to an inscription method for an electrical appliance having a control panel. More preferably, it relates to one in which information elements for a user of the electrical appliance are applied in a predetermined representation combination by an application device to the control panel.

### BACKGROUND OF THE INVENTION

An inscription method is generally known and is also described—in conjunction with a specific refinement—in the prior, not previously published, DE 100 05 461.7.

Electrical switching devices often have a mounting face, which is adjacent to the control panel, with mounting elements for an additional appliance. An additional appliance, for example an auxiliary switch, can be attached to the switching device on this face. As a rule, the additional appliance is in this case arranged on the left, alongside the electrical switching device. The combination of a switching device and an additional appliance is then mounted on a wall or in a switchgear cabinet.

If the additional appliance is intended to be mounted on the opposite side, this is not immediately possible, for design reasons. It would admittedly be possible just to rotate the switching device and the additional appliance through 180°, so that top and bottom, as well as left and right, are interchanged. However, all the inscriptions on the two appliances will then be upside down. There would thus be a considerable risk of incorrect actions being carried out in this case, in particular a risk of incorrect wiring. The prior art thus either dispenses with the other arrangement or requires a second version of the appliances, in which the additional appliance can be fitted on the right—or more generally in a different position.

### SUMMARY OF THE INVENTION

An object of an embodiment of the present invention is to provide a method. Preferably, by this method, this second version can be provided with as little effort as possible.

An object of an embodiment of the invention can be achieved by the application device having an associated control command. Further, information elements can be applied, depending on the control command, in the predetermined representation combination or in a different predetermined representation combination. This is because it is possible to leave the design and electrical construction of the appliances unchanged, and just to apply the information elements in an appropriately matched manner.

Generally, at least one of the information elements in the second representation combination is applied rotated through an angle with respect to the application in the first representation combination. The angle is preferably an integer multiple of 90°, in particular 180°.

If at least a first of the information elements in the first representation combination is positioned at a first location, and in the second representation combination is positioned at a second location, the arrangement of the information elements as is familiar to the user can also be essentially maintained in the second representation combination.

If a second of the information elements is positioned in the first representation combination at the second location, this information element in the second representation combination is positioned at a third location. The third location may, in particular, be identical to the first location.

If at least one additional information element is applied to the control panel in the second representation combination, and the additional information element in the first representation combination is not applied to the control panel, it is possible to provide the user with further information, as well, which he requires when applying the information elements in the second representation combination.

The information elements may, as such, be applied in any desired way. In particular, it is possible for the information elements to be applied by means of a laser inscription method, and for the information elements to be in the form of adhesive labels.

### BRIEF DESCRIPTION OF THE DRAWINGS

Further advantages and details can be found in the following description of an exemplary embodiment in conjunction with the drawings. In this case, illustrated in outline form:

FIG. 1 shows an inscription apparatus for an electrical appliance,

FIG. 2 shows an electrical switching device with an additional appliance, and

FIG. 3 shows a further electrical appliance with a further additional appliance.

### DETAILED DESCRIPTION OF THE PREFERRED EMBODIMENTS

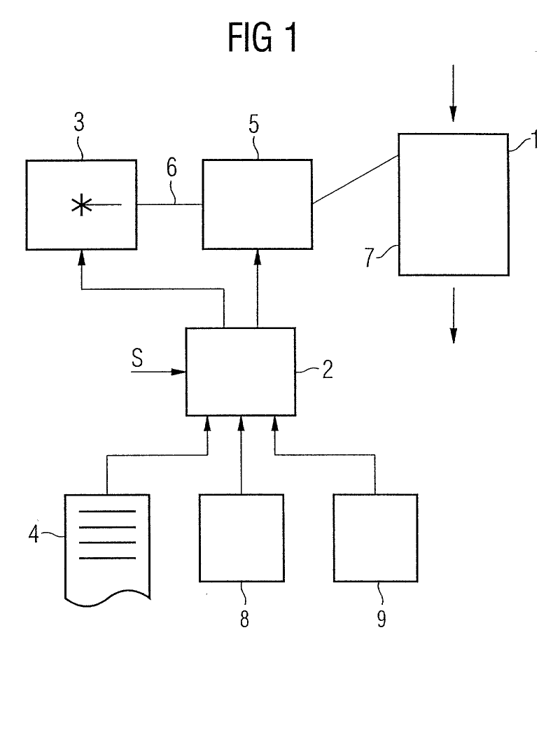

As shown in FIG. 1, an electrical appliance 1 is supplied to an inscription apparatus. The electrical appliance 1 may be, for example, a contactor, a relay, an electromechanical circuit breaker or an additional appliance for one of the abovementioned components. In particular, the additional appliance may be an electromechanical auxiliary switch.

A control unit 2 drives a laser 3 so that the latter is switched on or off in accordance with a control program 4. The control unit 2 furthermore drives a deflection device 5, via which a laser beam 6 which is emitted via the laser 3 can be deflected in two dimensions. By appropriately coordinated driving of the laser 3 and of the deflection device 5, the control unit 2 is thus able to apply information elements for a user (who is not shown) of the electrical appliance 1 to a control panel 7 of the electrical appliance 1. As shown in FIG. 1, the information elements are thus applied by a laser inscription method.

A control command S can be predetermined for the control unit 2 from the outside. The control command S can in this case be predetermined for the control unit 2 either manually or by a further, higher-level control unit, which is not shown. The control command S is of a binary nature, and may thus have the values 0 and 1. Depending on the value of the control command S, the information elements which are predetermined in the course of the control program 4 are applied to the control panel 7 either in a first representation combination or in a second representation combination. The representation combinations are, for example, stored in files 8, 9, and are thus predetermined.

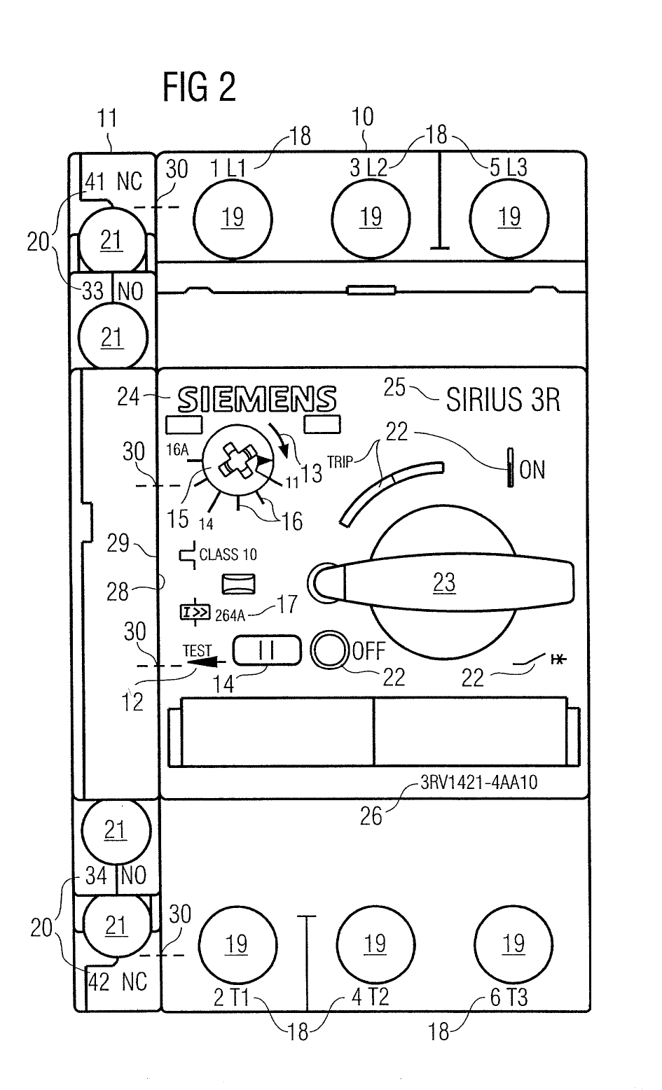

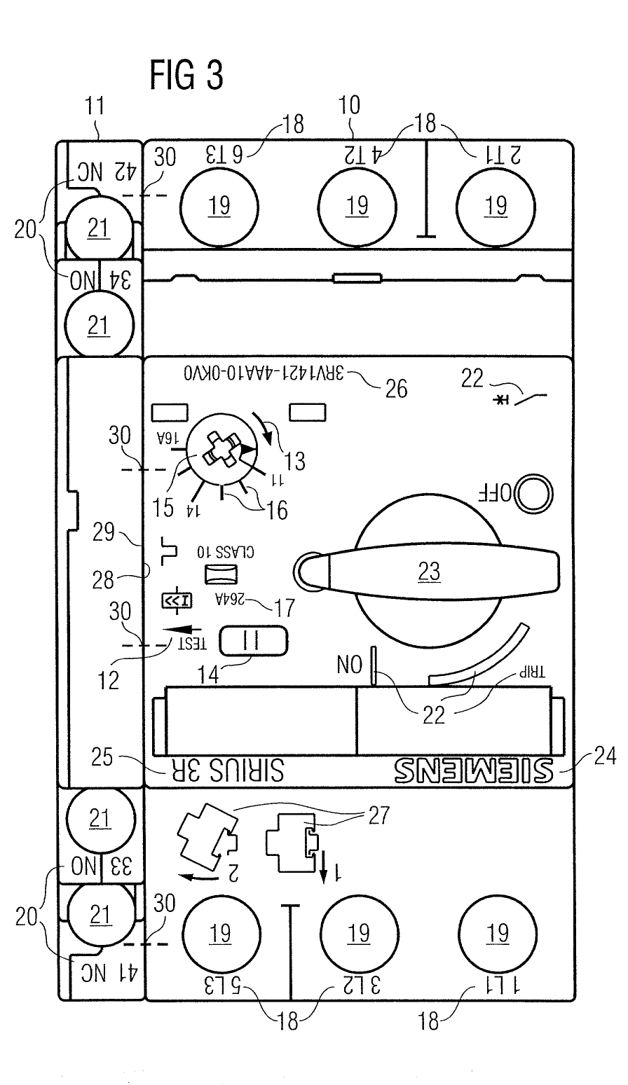

As examples of electrical appliances 1, FIG. 2 shows an electromechanical circuit breaker 10 and an auxiliary switch 11, for this circuit breaker 10, on both of which the information elements have been applied in the first representation combination. FIG. 3 shows the same circuit breaker 10 and the same auxiliary switch 11. These differ from the switches 10, 11 shown in FIG. 2 only in that the information elements have been applied to them in the second representation combination.

Thus, for example, the circuit breaker 10 has two arrows 12, 13 for a test switch 14 and for a rotary selector switch 15. These two information elements 12, 13 are arranged at the same location and in the same orientation in both representation combinations. A scale 16 for the rotary selector switch 15 is also the same in both representation combinations.

A large number of further information elements are, in contrast, admittedly arranged in the same location, but are rotated through an angle of 180°. These are all the elements which are intended to be read and understood by a user, but which have a fixed associated position on the circuit breaker 10. Examples of such information elements are the numerical values “11”, “14”, “16A” for the rotary selector switch 15, or the inscription “Test” for the test switch. An annotation 17 for the rating class of the switch 10 is also arranged at the same location, but rotated through 180°, in the two representation combinations.

Functional inscriptions 18 for screw connections 19 are, in contrast, not only rotated through 180°, but, furthermore, are also interchanged in opposite positions, in pairs. This means that the conductors L1 to L3 are in both cases supplied to the circuit breaker 10 from above, and the outgoers T1 to T3 leave the circuit breaker at the bottom. In a similar way, the functional inscriptions 20 for screw connections 21 of the auxiliary switch 11 are not only rotated through 180°, but are also interchanged with one another in pairs.

Functional inscriptions 22 for a rotary switch 23 for the circuit breaker 10, a manufacturer's designation 24 and a type designation 25 are also positioned both rotated through 180° and at a different location in the second representation combination as compared to the first representation combination.

Finally, part numbers 26 are also applied to the control panel 7 of the circuit breaker 10. These two part numbers 26 must, of course, be different to one another, since, although the relevant appliances are technically and functionally identical, their inscriptions are different.

Finally, additional information elements 27 are also applied to the circuit breaker 10 in the second representation combination. These additional information elements 27 indicate to the user of the circuit breaker 10 that he must install and remove this circuit breaker 10 in a different way to the normal way on a top-hat rail.

The circuit breaker 10 and the auxiliary switch 11 have mounting faces 28, 29. These mounting faces 28, 29 are adjacent to one another when in the mounted state. In this case, the auxiliary switch 11 is preferably latched in on the circuit breaker 10 via latching elements 30, which are indicated by dashed lines.

According to the exemplary embodiment, the information elements are applied, as already mentioned, by laser inscription. However, in principle, other inscription methods are also feasible. Thus, in particular, it is also possible for the information elements to be in the form of adhesive labels.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An inscription method for an electrical appliance including a control panel, comprising:
applying information elements for a user of the electrical appliance to the control panel by an application device; and
including, in association with the application device, an associated control command, wherein, depending on the control command, the information elements are applied by the application device in one of a predetermined first representation combination and a predetermined second representation combination.

2. The inscription method as claimed in claim 1,
wherein at least one of the information elements in the second representation combination, when applied, is applied rotated through an angle with respect to the application in the first representation combination.

3. The inscription method as claimed in claim 2, wherein the angle is an integer multiple of 90°, in particular 180°.

4. The inscription method as claimed in claim 1, wherein at least a first of the information elements in the first representation combination is positioned at a first location, and in the second representation combination is positioned at a second location.

5. The inscription method as claimed in claim 4, wherein a second of the information elements is positioned in the first representation combination at the second location, and in that the second of the information elements is positioned in the second representation combination at a third location.

6. The inscription method as claimed in claim 5, wherein the third location is identical to the first location.

7. The inscription method as claimed in claim 1, wherein, in the second representation combination, at least one additional information element is applied to the control panel, with the additional information element in the first representation combination not being applied to the control panel.

8. The inscription method as claimed in claim 1, wherein the information elements are applied via a laser inscription method.

9. The inscription method as claimed in claim 1, wherein the information elements are in the form of adhesive labels.

10. A group of electrical appliances, inscripted by method as claimed in claim 1, wherein the information elements are applied to at least one of the appliances in the first representation combination, and to at least one of the appliances in the second representation combination.

11. The group of electrical appliances as claimed in claim 10, wherein the appliances are electrical switching devices, and include a mounting face, adjacent to the control panel, with at least one mounting element for an additional appliance.

12. The group of electrical appliances as claimed in claim 10, wherein the appliances include additional appliances for electrical switching devices, and include a mounting face, adjacent to the control panel, with at least one mounting element for attachment to an electrical switching device.

13. The inscription method as claimed in claim 2, wherein at least a first of the information elements in the first representation combination is positioned at a first location, and in the second representation combination is positioned at a second location.

14. The inscription method as claimed in claim 13, wherein a second of the information elements is positioned in the first representation combination at the second location, and in that the second of the information elements is positioned in the second representation combination at a third location.

15. The inscription method as claimed in claim 14, wherein the third location is identical to the first location.

16. The inscription method as claimed in claim 3, wherein at least a first of the information elements in the first representation combination is positioned at a first location, and in the second representation combination is positioned at a second location.

17. The inscription method as claimed in claim 16, wherein a second of the information elements is positioned in the first representation combination at the second location, and in that the second of the information elements is positioned in the second representation combination at a third location.

18. The inscription method as claimed in claim 17, wherein the third location is identical to the first location.

19. The inscription method as claimed in claim 2, wherein the information elements are applied via a laser inscription method.

20. The inscription method as claimed in claim 2, wherein the information elements are in the form of adhesive labels.

21. The inscription method as claimed in claim 3, wherein the information elements are applied via a laser inscription method.

22. The inscription method as claimed in claim 3, wherein the information elements are in the form of adhesive labels.

23. The inscription method as claimed in claim 4, wherein the information elements are applied via a laser inscription method.

24. The inscription method as claimed in claim 4, wherein the information elements are in the form of adhesive labels.

25. An electric appliance inscripted by the method of claim 1.
